(19) United States
(12) Patent Application Publication
(10) Pub. No.: US 2024/0424445 A1
(43) Pub. Date: Dec. 26, 2024

(54) ZONED THREE-WAY CONVERSION CATALYSTS COMPRISING PLATINUM, PALLADIUM, AND RHODIUM

(71) Applicant: BASF CORPORATION, Florham Park, NJ (US)

(72) Inventors: Xiaolai ZHENG, Iselin, NJ (US); Stephen JOHNSON, Southfield, MI (US); Yipeng SUN, Iselin, NJ (US); Yuejin LI, Iselin, NJ (US); Shiang SUNG, Iselin, NJ (US); Chunxin JI, Iselin, NJ (US); Pascaline TRAN, Iselin, NJ (US); Pramod RAVINDRAN, Southfield, MI (US); Karifala DUMBUYA, Hannover (DE)

(21) Appl. No.: 18/692,603

(22) PCT Filed: Sep. 8, 2022
(86) PCT No.: PCT/EP2022/074936

§ 371 Date: Mar. 15, 2024

(30) Foreign Application Priority Data
Sep. 17, 2021 (EP) 21197341.7

(51) Int. Cl. B01D 53/94; B01J 21/04; B01J 23/10; B01J 23/63; B01J 35/00; B01J 37/02; B01J 37/08; F01N 3/10; F01N 3/28

(52) U.S. Cl. CPC B01D 53/945; B01D 53/9468; B01D 53/9472; B01J 21/04; B01J 23/10; B01J 23/63; B01J 35/19; B01J 37/0228; B01J 37/0244; B01J 37/08; F01N 3/101; F01N 3/2825; B01D 2255/1021; B01D 2255/1023; B01D 2255/1025; B01D 2255/9022; B01D 2255/9032; B01D 2255/9155; B01D 2257/404; B01D 2257/502; B01D 2257/702; F01N 2510/0684

(57) ABSTRACT

The present invention provides a catalytic article comprising a substrate: a bottom washcoat deposited on the substrate; and a top washcoat deposited on the bottom coat, wherein the bottom washcoat comprises a zoned configuration, wherein the zoned configuration comprises a first zone and a second zone, wherein the first zone comprises palladium supported on ceria-zirconia mixed oxide or alumina or both, wherein the second zone comprises platinum supported on a ceria-alumina composite, wherein the top washcoat comprises rhodium supported on an alumina or a ceria-alumina composite. The present invention also provides a process for the preparation of the catalytic article, and it use for purifying a gaseous exhaust stream.

### FIELD OF THE INVENTION

The presently claimed invention relates to a catalyst useful for the treatment of exhaust gases to reduce contaminants contained therein. Particularly, the presently claimed invention relates to a catalytic article comprising zoned three-way conversion (TWC) catalysts comprising platinum, palladium, and rhodium.

### BACKGROUND OF THE INVENTION

Three-way conversion (TWC) catalysts are well known for their catalytic activity of reducing pollutants such as NO, CO and HC using platinum group metals (PGM). A conventional TWC catalyst uses Pd and Rh as active catalytic components. In consideration of the current PGM market price, to replace a part of more expensive Pd with less expensive Pt in TWC catalysts would help catalytic converter manufacturers and automobile manufacturers to reduce the cost significantly. Accordingly, the current invention is focused on developing a highly active, zoned TWC catalyst comprising platinum, palladium, and rhodium as the PGM components. It is found that the replacement of a substantial amount of Pd with Pt (e.g., 50%) in TWC catalysts is feasible for applications with relatively high engine-out temperatures. However, for applications with relatively low engine-out temperatures, HC slip can become an issue, especially during the cold start period of drive cycles.

Accordingly, it is desired to design a Pt/Pd/Rh-based TWC catalyst in an appropriate architecture to improve the emission control efficiency, especially the low temperature HC performance.

### OBJECT OF THE INVENTION

The object of the present invention is to improve the HC cold start performance of three-way conversion (TWC) catalysts comprising Pt, Pd and Rh as active platinum group metal (PGM) components.

### SUMMARY OF THE INVENTION

The present invention provides a catalytic article comprising a substrate; a bottom washcoat deposited on the substrate; and a top washcoat deposited on the bottom washcoat, wherein the bottom washcoat comprises a zoned configuration, wherein the zoned configuration comprises a first zone and a second zone, wherein the first zone comprises palladium supported on ceria-zirconia mixed oxide or alumina or both, wherein the second zone comprises platinum supported on a ceria-alumina composite, wherein the top washcoat comprises rhodium supported on an alumina or a ceria-alumina composite.

The present invention also provides a process for the preparation of the catalytic article, wherein the process comprises a) preparing a bottom washcoat comprising a first zone and a second zone, wherein the first zone is obtained by preparing a first slurry comprising palladium supported on the ceria-zirconia mixed oxide or alumina or both and coating said first slurry on a first portion of the substrate; wherein the second zone is obtained by preparing a second slurry comprising platinum supported on the ceria-alumina composite; and coating said second slurry on a second portion of the substrate, b) preparing a top washcoat by depositing a third slurry comprising rhodium supported on an alumina on the bottom washcoat, and c) subjecting the substrate to calcination at a temperature ranging from 400 to 700° C., wherein the step of preparing the slurry comprises a technique selected from incipient wetness impregnation, incipient wetness co-impregnation, or post-addition.

### BRIEF DESCRIPTION OF THE DRAWINGS

In order to provide an understanding of the embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIGS. 1A and 1B illustrate the two-layered non-zoned catalytic articles according to the comparative examples.

FIGS. 1C to 1J illustrate the two-layered zoned catalytic articles according to the illustrative examples of the present invention.

FIG. 2A is a perspective view of a honeycomb-type substrate carrier which may comprise the catalyst composition in accordance with one embodiment of the presently claimed invention.

FIG. 2B is a partial cross-section view enlarged relative to FIG. 2A and taken along a plane parallel to the end faces of the substrate carrier of FIG. 2A, which shows an enlarged view of a plurality of the gas flow passages shown in FIG. 2A.

FIG. 3 is a cutaway view of a section enlarged relative to FIG. 2A, wherein the honeycomb-type substrate in FIG. 2A represents a wall flow filter substrate monolith.

### DETAILED DESCRIPTION

The presently claimed invention will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

### Definitions

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

In the context of the present invention the term “first layer” is interchangeably used for “bottom layer”, “bottom coat”, or “bottom washcoat”, whereas the term “second layer” is interchangeably used for “top layer”, “top coat”, or “top washcoat”. The first layer is deposited at least on a part of the substrate and the second layer is deposited at least on a part of the first layer.

In the context of the present invention the term “first zone” is interchangeably used for “inlet zone” or “front zone” and the term “second zone” is interchangeably used for “outlet zone” or “rear zone” The terms “first zone” and “second zone” also describe the relative positioning of the catalytic article in flow direction, respectively the relative positing of the catalytic article when placed in an exhaust gas treatment system. The first zone would be positioned upstream, whereas the second zone would be positioned downstream. The first zone covers at least some portion of the substrate from the inlet of the substrate, whereas the second zone covers at least some portion of the substrate from the outlet of the substrate.

The inlet of the substrate is a first end which is capable to receive the flow of an engine exhaust gas stream from an engine, whereas the outlet of the substrate is a second end from which a treated exhaust gas stream exits.

The term “three-way conversion catalyst” or TWC catalyst refers to a catalyst that simultaneously promotes a) reduction of nitrogen oxides to nitrogen and oxygen; b) oxidation of carbon monoxide to carbon dioxide; and c) oxidation of unburnt hydrocarbons to carbon dioxide and water.

The term “NOx” refers to nitrogen oxide compounds, such as NO and/or NO₂.

As used herein, the term “washcoat” has its usual meaning in the art of a thin, adherent coating of a catalytic or other material applied to a substrate material. Generally, a washcoat is formed by preparing a slurry containing a certain solid content (e.g., 15-60% by weight) of particles in a liquid vehicle, which is then coated onto a substrate and dried to provide a washcoat layer.

Hydrothermal stability of a catalyst may be functionally defined as retaining sufficient catalytic function after a high temperature aging. Specifically, in this context, hydrothermal stability means that after an aging treatment at a temperature ranging from 850° C. to 1050° C. for about 5 to 300 hours with steam, the catalyst should have NOx and hydrocarbon light-off temperatures lower than 350° C.

As used herein, the term “stream” broadly refers to any combination of flowing gas that may contain solid or liquid particulate matters.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

In the context of the present invention, the amount of platinum group metal/s such as platinum/palladium/rhodium, and/or support material such as ceria-zirconia mixed oxide, ceria-alumina composite, alumina etc is calculated as weight %, based on the total weight of the washcoats present on the substrate. i.e. the amount is calculated without considering the substrate amount, though substrate is part of the catalytic article. The washcoat comprise the top washcoat, bottom washcoat and optionally any further coating layer. Preferably, the washcoats are the top washcoat and bottom washcoat.

The present invention focused on addressing the low temperature HC breakthrough problem associated with a conventional Pt/Pd/Rh trimetal TWC technology. Accordingly, a Pt/Pd/Rh-based TWC catalytic article with a zoned washcoat architecture is designed. The invention designs allow for a Pd-enriched inlet zone (first zone) for a fast HC light-off during cold start and utilize a Pt-enriched outlet zone (second zone) for HC hot performance after the light-off. Vehicle and engine evaluation data demonstrated that the invention catalytic article shows improvement in HC conversion compared to the non-zoned designs.

### Catalytic Article:

The present invention in a first aspect provides a catalytic article comprising:
a) a substrate;
b) a bottom washcoat deposited on the substrate; and
c) a top washcoat deposited on the bottom coat,
wherein the bottom washcoat comprises a zoned configuration,
wherein the zoned configuration comprises a first zone and a second zone,
wherein the first zone comprises palladium supported on ceria-zirconia mixed oxide or alumina or both,
wherein the second zone comprises platinum supported on a ceria-alumina composite,
wherein the top washcoat comprises rhodium supported on an alumina or a ceria-alumina composite.

### Support Materials:

A “support” in a catalytic material or catalyst composition or catalyst washcoat refers to a material that receives metals (e.g., PGMs), stabilizers, promoters, binders, and the like through precipitation, association, dispersion, impregnation, or other suitable methods.

### Ceria-Alumina Composite:

Ceria-alumina composite is a composite in which CeO₂ is distributed on the surface of alumina and/or in the bulk as particles and/or nano clusters. Each oxide may have its distinct chemical and solid physical state; however, the oxides can interact through their interface. The surface CeO₂ modification of alumina can be in the form of discrete moieties (particles or clusters) or in the form of a layer of ceria that covers the surface of alumina partially or completely.

The amount of CeO₂ (cerium oxide) in the ceria-alumina composite present in the top and/or bottom washcoat is preferably 1.0 to 50 wt. %, based on the total weight of the ceria-alumina composite. More preferably, the CeO₂ in the ceria-alumina composite present in the top and/or bottom washcoat is 5.0 to 50 wt. %, based on the total weight of the ceria-alumina composite. Even more preferably the CeO₂ in the ceria-alumina composite present in the top and/or bottom washcoat is 5 to 30 wt. %, based on the total weight of the ceria-alumina composite. And even more preferably, the CeO₂ in the ceria-alumina composite present in the top and/or bottom washcoat is 8 to 20 wt. %, based on the total weight of the ceria-alumina composite.

The amount of Al₂O₃ (aluminium oxide) in the ceria-alumina composite present in the top and/or bottom washcoat is preferably 50 to 99 wt. % based on the total weight of the ceria-alumina composite. More preferably, the Al₂O₃ in the ceria-alumina composite present in the top and/or bottom washcoat is 50 to 95 wt. % based on the total weight of the ceria-alumina composite. Even more preferably, the Al₂O₃ in the ceria-alumina composite present in the top and/or bottom washcoat is 70 to 95 wt. % based on the total weight of the ceria-alumina composite. And even more preferably, the Al₂O₃ in the ceria-alumina composite present in the top and/or bottom washcoat is 80 to 92 wt. %, based on the total weight of the ceria-alumina composite.

Preferably, the average particle size of ceria in the ceria-alumina composite is less than 200 nm. Preferably, the particles size is in the range of 5.0 nm to 50 nm. The particle size is determined by transition electron microscopy.

The ceria-alumina composite present in the top and/or bottom washcoat may comprise a dopant selected from zirconia, lanthana, titania, hafnia, magnesia, calcia, strontian, baria or any combination thereof. The total amount of dopant in the ceria-alumina composite is preferably in the range of 0.001 to 15 wt. % based on the total weight of the ceria-alumina composite.

The ceria-alumina composite can be made by methods known to the person skilled in the art like co-precipitation or surface modification. In these methods, a suitable cerium containing precursor is brought into contact with a suitable aluminium containing precursor and the so obtained mixture is then transformed into the ceria-alumina composite. Suitable cerium containing precursors are for example water soluble cerium salts and colloidal ceria suspension. Ceria-alumina can also be prepared by the atomic layer deposition method, where a ceria compound selectively reacts with an alumina surface, which after calcination forms ceria on the alumina surface. This deposition/calcination step can be repeated until a layer of desired thickness is reached. Suitable aluminium containing precursors are for example aluminium oxides like gibbsite, boehmite gamma alumina, delta alumina or theta alumina or their combinations. Transformation of the so obtained mixture into the ceria-alumina composite can then be achieved by a calcinations step of the mixture.

### Ceria-Zirconia Mixed Oxide (CZO):

The term of complex metal oxide refers to a mixed metal oxide that contains oxygen anions and at least two different metal cations. In the ceria-zirconia mixed oxide, cerium cations, zirconium cations are distributed within the oxide lattice structure. The terms “complex oxide” and “mixed oxide” can be used interchangeably. As the metal cations are distributed within the oxide lattice structure, these structures are also commonly referred to as solid solutions.

Preferably, ceria (calculated as CeO₂) of the ceria-zirconia mixed oxide present in the top and/or bottom washcoat is present in an amount of 10 to 75 wt. %, based on the total weight of the ceria-zirconia mixed oxide and zirconia (calculated as ZrO₂) of the ceria-zirconia mixed oxide present in the top and/or bottom washcoat is present in an amount of 25 to 90 wt. %, based on the total weight of the ceria-zirconia mixed oxide.

More preferably, ceria (calculated as CeO₂) of the ceria-zirconia mixed oxide present in the top and/or bottom washcoat is present in an amount of 20 to 50 wt. %, based on the total weight of the ceria-zirconia mixed oxide and zirconia (calculated as ZrO₂) of the ceria-zirconia mixed oxide present in the top and/or bottom washcoat is present in an amount of 50 to 80 wt. %, based on the total weight of the ceria-zirconia mixed oxide.

Even more preferably, ceria (calculated as CeO₂) of the ceria-zirconia mixed oxide present in the top and/or bottom washcoat is present in an amount of 30 to 50 wt. %, based on the total weight of the ceria-zirconia mixed oxide and zirconia (calculated as ZrO₂) of the ceria-zirconia mixed oxide present in the top and/or bottom washcoat is present in an amount of 50 to 70 wt. %, based on the total weight of the ceria-zirconia mixed oxide.

In a preferred embodiment, the ceria-zirconia mixed oxide present in the top and/or bottom washcoat comprises a dopant selected from lanthana, titania, hafnia, magnesia, calcia, strontia, baria, yttrium, hafnium, praseodymium, neodymium, or any combinations thereof. The dopant metal may be incorporated in a cationic form into the crystal structure of the complex metal oxide, may be deposited in an oxidic form on the surface of the complex metal oxide, or may be present in the oxidic form as a blend of mixtures of both dopants and complex metal oxide on a micro-scale. The dopant(s) are comprised in an amount of 1-20 wt. %, or more preferably in an amount of 5-15 wt. %, based on the total weight of the complex metal oxide.

### Alumina:

Alumina present in the top and/or bottom washcoat can be gamma alumina or activated alumina. It typically exhibits a BET surface area of fresh material in excess of 60 square meters per gram (“m²/g”), often up to about 200 m²/g or higher. Activated alumina is usually a mixture of the gamma and delta phases of alumina, but may also contain substantial amounts of eta, kappa and theta alumina phases. The activated alumina includes high bulk density gamma-alumina, low or medium bulk density large pore gamma-alumina, low bulk density large pore boehmite or gamma-alumina. Alumina present in the top and/or bottom washcoat can be doped with a dopant selected from barium, lanthana, zirconia, neodymian, yttria or titania, wherein the amount of the dopant is preferably 1.0 to 30 wt. % based on the total weight of alumina and dopant. Examples of alumina doped with dopant/s include but not limited to lanthana-alumina, titania-alumina, ceria-zirconia-alumina, zirconia-alumina, lanthana-zirconia-alumina, baria-alumina, baria-lanthana-alumina, baria-lanthana-neodymia-alumina, or any combination thereof.

### Substrate:

The substrate of the catalytic article of the presently claimed invention may be constructed of any material typically used for preparing automotive catalysts. In a preferred embodiment, the substrate is a ceramic substrate, metal substrate, ceramic foam substrate, polymer foam substrate or a woven fiber substrate. In a more preferred embodiment, the substrate is a ceramic or a metal monolithic honeycomb structure. The substrate provides a plurality of wall surfaces upon which washcoat comprising the catalyst compositions described herein above are applied and adhered, thereby acting as a carrier for the catalyst compositions.

Preferable metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g. 10-25 wt. % of chromium, 3-8% of aluminium, and up to 20 wt. % of nickel. The alloys may also contain small or trace amounts of one or more metals such as manganese, copper, vanadium, titanium, and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Preferable ceramic materials used to construct the substrate may include any suitable refractory material, e.g., cordierite, mullite, cordierite-alumina, silicon nitride, zircon mullite, spodumene, alumina-silica magnesia, zircon silicate, sillimanite, magnesium silicates, zircon, petalite, alumina, aluminosilicates, and the like.

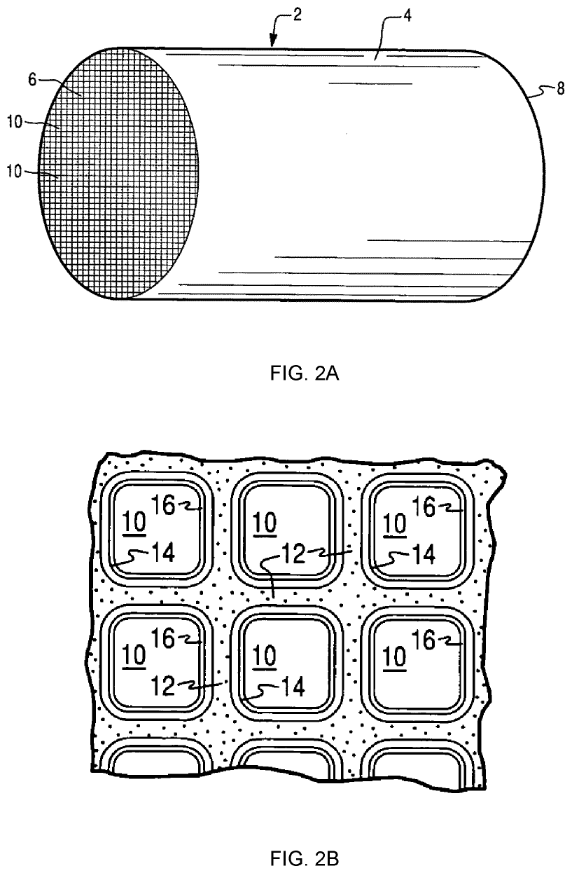

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminium-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure. FIGS. 2A and 2B illustrate an exemplary substrate 2 in the form of a flow-through substrate coated with washcoat compositions as described herein. Referring to FIG. 2A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 2B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 2B, walls 12 are so dimensioned and configured that gas flow passages 10 have a substantially regular polygonal shape. As shown, the washcoat compositions can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

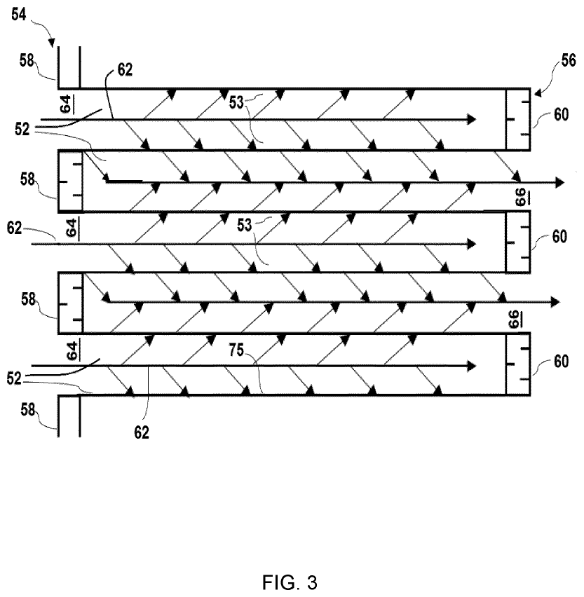

FIG. 3 illustrates an exemplary substrate 2 in the form of a wall flow filter substrate coated with a washcoat composition as described herein. As seen in FIG. 3, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist of all, or in part, of the catalytic material. This invention includes the use of one or more layers of catalytic material on the inlet and/or outlet walls of the element.

### Washcoat/s on Substrate:

### Bottom Coat:

The bottom washcoat is deposited on the substrate. Preferably, the bottom washcoat covers 90 to 100% of the surface of the substrate. More preferably, the bottom washcoat covers 95 to 100% of the surface of the substrate and even more preferably, the bottom washcoat covers the whole accessible surface of the substrate. The term “accessible surface” refers to the surface of the substrate which can be covered with the conventional coating techniques used in the field of catalyst preparation like impregnation techniques.

The bottom washcoat comprises a zoned configuration, wherein the zoned configuration comprises a first zone and a second zone.

Preferably, the first zone and the second zone together cover 50 to 100% of length of the substrate. More preferably, the first and second zone together cover 90 to 100% of the length of the substrate and even more preferably, the first and the second zone together cover the whole length of the substrate.

Preferably, the first zone covers 10 to 90% of the entire substrate length from an inlet and the second zone covers 90 to 10% of the entire substrate length from an outlet, while the first zone and the second zone together cover 20 to 100% of the length of the substrate. More preferably, the first zone covers 20 to 80% of the entire substrate length from the inlet and the second zone covers 80 to 20% of the entire substrate length from the outlet, while the first zone and the second zone together cover 40 to 100% of the length of the substrate. Even more preferably, the first zone covers 30 to 70% of the entire substrate length from the inlet and the second zone covers 70 to 30% of the entire substrate length from the outlet, while the first zone and the second zone together cover 60 to 100% of the length of the substrate. Even most preferably, the first zone covers 40 to 50% of the entire substrate length from the inlet and the second zone covers 50 to 40% of the entire substrate length from the outlet, while the first zone and the second zone together cover 80 to 100% of the length of the substrate.

### First Zone in the Bottom Coat:

The first zone in the bottom washcoat comprises palladium supported on the ceria-zirconia mixed oxide or alumina or both. The term “supported” throughout this application has the general meaning as in the field of heterogenous catalysis. In general, the term “supported” refers to an affixed catalytically active species or its respective precursor to a support material. The support material may be inert or participate in the catalytic reaction. Commonly supported catalysts are prepared by impregnation methods or co-precipitation methods and optional subsequent calcination.

The amount of ceria-zirconia mixed oxide in the first zone is in the range of 10 to 90 wt. %, based on the total weight of the washcoats. Preferably, the amount of ceria-zirconia mixed oxide in the first zone is in the range of 20 to 80 wt. %, based on the total weight of the washcoats. More preferably, the of amount ceria-zirconia mixed oxide in the first zone is in the range of 30 to 70 wt. %, based on the total weight of the washcoats.

The ceria-zirconia mixed oxide preferably comprises ceria, calculated as CeO₂ in an amount of about 20 to 50 wt. %, based on the total weight of the ceria-zirconia mixed oxide present in the first zone; and zirconia, calculated as ZrO₂ in an amount of about 50 to about 80 wt. %, based on the total weight the ceria-zirconia mixed oxide present in the first zone. More preferably, the ceria-zirconia mixed oxide comprises ceria, calculated as CeO₂ in an amount of about 30 to 50 wt. %, based on the total weight of the ceria-zirconia mixed oxide present in the first zone; and zirconia, calculated as ZrO₂ in an amount of about 50 to about 70 wt. %, based on the total weight the ceria-zirconia mixed oxide present in the first zone.

The amount of alumina in the first zone is preferably in the range of 5.0 to 90 wt. %, based on the total weight of the washcoats. More preferably, the amount of alumina in the first zone is in the range of 10 to 80 wt. %, based on the total weight of the washcoats. More preferably, the amount of alumina in the first zone is in the range of 10 to 70 wt. %, based on the total weight of the washcoats.

In the first zone, palladium is supported on the ceria-zirconia mixed oxide. The amount of palladium in the first zone is preferably 50 to 100 wt. %, based on the total weight of palladium in the washcoats. Preferably, the amount of palladium in the first zone is 75 to 100 wt. %, based on the total weight of palladium in the washcoats. More preferably, the amount of palladium in the first zone is 80 to 100 wt. %, based on the total weight of palladium in the washcoats.

Alternatively, palladium is supported on alumina. Furthermore, palladium can be supported on both support materials, namely ceria-zirconia mixed oxide and alumina. The amount of palladium distributed on the ceria-zirconia mixed oxide is 40 to 80% of the total palladium present in the first zone and the amount of palladium distributed on alumina is 20 to 60% of the total palladium present in the first zone. Preferably, palladium is distributed equally on the ceria-zirconia mixed oxide and alumina.

Preferably, the first zone further comprises platinum supported on the ceria-alumina composite. The amount of platinum in the first zone is preferably 0.01 to 50 wt. %, based on the total weight of platinum in the washcoats. More preferably, the amount of platinum in the first zone is 1.0 to 30 wt. %, based on the total weight of platinum in the washcoats. More preferably, the amount of platinum in the first zone is 5.0 to 25 wt. %, based on the total weight of platinum in the washcoats.

Preferably the amount of the ceria-alumina composite in the first zone is in the range of 1.0 to 80 wt. %, based on the total weight of the washcoats. More preferably, the amount of the ceria-alumina composite in the first zone is in the range of 10 to 70 wt. %, based on the total weight of the washcoats. More preferably, the amount of the ceria-alumina composite in the first zone is in the range of 10 to 50 wt. %, based on the total weight of the washcoats.

Preferably the amount of ceria, calculated as CeO₂ in the ceria-alumina composite is 1.0 to 50 wt. %, based on the total weight of the ceria-alumina composite. More preferably, the amount of ceria, calculated as CeO₂ in the ceria-alumina composite is 5.0 to 50 wt. %, based on the total weight of the ceria-alumina composite. More preferably, the amount of ceria, calculated as CeO₂ in the ceria-alumina composite is 5.0 to 30 wt. %, based on the total weight of the ceria-alumina composite. Even more preferably, the amount of ceria, calculated as CeO₂ in the ceria-alumina composite is 8.0 to 20 wt. %, based on the total weight of the ceria-alumina composite.

### Second Zone in the Bottom Coat:

The second zone in the bottom washcoat comprises platinum supported on the ceria-alumina composite. Preferably the amount of platinum supported on the ceria-alumina composite is in an amount of 50 to 100 wt. %, based on the total weight of platinum in the washcoats. Preferably, the amount of platinum supported on the ceria-alumina composite in an amount of 75 to 100 wt. %, based on the total weight of platinum in the washcoats.

Preferably, the amount of the ceria-alumina composite in the second zone is in the range of 1.0 to 80 wt. %, based on the total weight of the washcoats. More preferably, the amount of the ceria-alumina composite in the second zone is in the range of 10 to 70 wt. %, based on the total weight of the washcoats. More preferably, the amount of the ceria-alumina composite in the second zone is in the range of 10 to 50 wt. %, based on the total weight of the washcoats.

Preferably the amount of ceria, calculated as CeO₂ in the ceria-alumina composite is 1.0 to 50 wt. %, based on the total weight of the ceria-alumina composite. More preferably, the amount of ceria, calculated as CeO₂ in the ceria-alumina composite is 5.0 to 50 wt. %, based on the total weight of the ceria-alumina composite. More preferably, the amount of ceria, calculated as CeO₂ in the ceria-alumina composite is 5.0 to 30 wt. %, based on the total weight of the ceria-alumina composite. Even more preferably, the amount of ceria, calculated as CeO₂ in the ceria-alumina composite is 8.0 to 20 wt. %, based on the total weight of the ceria-alumina composite.

The second zone in the bottom washcoat further comprises palladium supported on the ceria-zirconia mixed oxide. Preferably the second zone comprises 0.01 to 50 wt. % of palladium supported on the ceria-zirconia mixed oxide, based on the total weight of the palladium in the washcoats. More Preferably, the second zone comprises 1.0 to 30 wt. % of palladium supported on the ceria-zirconia mixed oxide, based on the total weight of the palladium in the washcoats. More preferably, the second zone comprises 5.0 to 25 wt. % of palladium supported on the ceria-zirconia mixed oxide, based on the total weight of the palladium in the washcoats.

Preferably the amount ceria-zirconia mixed oxide in the second zone is in the range of 10 to 90 wt. %, based on the total weight of the washcoats. More preferably, the amount ceria-zirconia mixed oxide in the second zone is in the range of 20 to 80 wt. %, based on the total weight of the washcoats. More preferably, the amount ceria-zirconia mixed oxide in the second zone is in the range of 30 to 70 wt. %, based on the total weight of the washcoats.

Preferably the ceria-zirconia mixed oxide comprises ceria, calculated as CeO₂ in an amount of about 20 to 50 wt. %, based on the total weight of the ceria-zirconia mixed oxide; and zirconia, calculated as ZrO₂ in an amount of about 50 to about 80 wt. %, based on the total weight the ceria-zirconia mixed oxide. More preferably, the ceria-zirconia mixed oxide comprises ceria, calculated as CeO₂ in an amount of about 30 to 50 wt. %, based on the total weight of the ceria-zirconia mixed oxide; and zirconia, calculated as ZrO₂ in an amount of about 50 to about 70 wt. %, based on the total weight the ceria-zirconia mixed oxide.

Preferably, the total amount of ceria-zirconia mixed oxide in the first zone is equal to the total amount of ceria-zirconia mixed oxide in the second zone. i.e. the weight ratio of the ceria-zirconia mixed oxide in the first zone to the ceria-zirconia mixed oxide in the second zone is 1:1. More preferably, the total amount of ceria-zirconia mixed oxide in the first zone is higher than the total amount of ceria-zirconia mixed oxide in the second zone. More preferably, the total amount of ceria-zirconia in the first zone is at least 1.1 to 1.5 times higher compared to the total amount of ceria-zirconia in the second zone. i.e. wherein the weight ratio of the ceria-zirconia mixed oxide in the first zone to the ceria-zirconia mixed oxide in the second zone is 1.1:1.0 to 1.5:1. With the increased ceria-zirconia (CZO) loading together with the enriched Pd in the inlet zone, improved NMHC performance is observed. These findings indicated the feasibility of using the zoned washcoat architecture with Pd-enrichment and the OSC boost in the inlet zone to achieve 50% substitution of Pd with Pt.

### Top Washcoat:

The top washcoat is deposited on the bottom coat. Preferably, the top washcoat covers 10 to 100% of the surface of the bottom coat. Preferably, the top washcoat covers 50 to 100% of the surface of the substrate, more preferably, the top washcoat covers 90 to 100% of the surface of the substrate, and even more preferably, the top washcoat covers the whole accessible surface of the substrate.

The top washcoat comprises rhodium supported on an alumina or a ceria-alumina composite. Alumina is preferably selected from alumina, lanthana-alumina, titania-alumina, ceria-zirconia-alumina, zirconia-alumina, lanthana-zirconia-alumina, baria-alumina, baria-lanthana-alumina, baria-lanthana-neodymia-alumina, or any combination thereof. Alumina can be doped with a dopant selected from barium, lanthana, zirconia, neodymian, yttria or titania, wherein the amount of the dopant is 1.0 to 30 wt. % based on the total weight of alumina and dopant. The amount of alumina in the top washcoat is preferably 1.0 to 80 wt. %, based on the total weight of the washcoats. More preferably, the amount of alumina in the top washcoat is 5.0 to 70 wt. %, based on the total weight of the washcoats. More, preferably, the amount of alumina in the top washcoat is 5.0 to 50 wt. %, based on the total weight of the washcoats. The amount of the ceria-alumina composite in the top washcoat is preferably in the range of 1.0 to 80 wt. %, based on the total weight of the washcoats. Preferably, the amount of the ceria-alumina composite in the top washcoat is in the range of 10 to 70 wt. %, based on the total weight of the washcoats. More preferably, the amount of the ceria-alumina composite in the top washcoat is in the range of 10 to 50 wt. %, based on the total weight of the washcoats. Preferably the amount of ceria, calculated as CeO₂ in the ceria-alumina composite is 1.0 to 50 wt. %, based on the total weight of the ceria-alumina composite. More preferably, the amount of ceria, calculated as CeO₂ in the ceria-alumina composite is 5.0 to 50 wt. %, based on the total weight of the ceria-alumina composite. More preferably, the amount of ceria, calculated as CeO₂ in the ceria-alumina composite is 5.0 to 30 wt. %, based on the total weight of the ceria-alumina composite. Even more preferably, the amount of ceria, calculated as CeO₂ in the ceria-alumina composite is 8.0 to 20 wt. %, based on the total weight of the ceria-alumina composite.

The top washcoat and/or bottom washcoat further comprises one or more promoter. As used herein, the term “promoter” refers to a component that is intentionally added to the support material to enhance an activity of the catalyst as compared to the catalyst that does not have a promoter intentionally added. The exemplary promoter includes barium oxide or strontium oxide.

Additionally, the top washcoat and/or bottom washcoat may further contain a binder in the form of alumina, colloidal alumina, silica, zirconium acetate, colloidal zirconia, or zirconium hydroxide, associative thickeners, and/or surfactants (including anionic, cationic, non-ionic, or amphoteric surfactants). Other exemplary binders include boehmite, gamma-alumina, or delta/theta alumina, as well as silica sol. When present, the binder is typically used in an amount of about 1.0-5.0 wt. % of the total weight of the washcoats. The aluminas which are used as binders are regarded as separate to the aluminas which are used as support materials.

Preferably, the amount of palladium is in the range of 0.02 to 2 wt. %, based on the total weight of the washcoats. More preferably, the amount of palladium is in the range of 0.05 to 1.5 wt. %, based on the total weight of the washcoats. More preferably, the amount of palladium is in the range of 0.05 to 1.0 wt. %, based on the total weight of the washcoats. Preferably the amount of platinum is in the range of 0.02 to 2 wt. %, based on the total weight of the washcoats. More preferably, the amount of platinum is in the range of 0.05 to 1.5 wt. %, based on the total weight of the washcoats. More preferably, the amount of platinum is in the range of 0.05 to 1.0 wt. %, based on the total weight of the washcoats. Preferably the amount of rhodium is in the range of 0.01 to 0.5 wt. %, based on the total weight of the washcoats. More preferably, the amount of rhodium is in the range of 0.05 to 0.5 wt. %, based on the total weight of the washcoats. More preferably, the amount of rhodium is in the range of 0.05 to 0.3 wt. %, based on the total weight of the washcoats.

The weight proportion of palladium to platinum in the catalytic article is 9:1 to 1:13. Preferably, the weight proportion of palladium to platinum in the catalytic article is 3:1 to 1:1. The weight proportion of rhodium to palladium is 1:100 to 1:3. The weight proportion of rhodium to platinum is 1:100 to 1:3.

### Preparation of Catalytic Article:

In another aspect of the present invention, there is also provided a process for the preparation of a catalytic article described herein above. The process comprises preparing a bottom washcoat comprising a first zone and a second zone; and a top washcoat. The first zone is obtained by preparing a first slurry comprising palladium supported on the ceria-zirconia mixed oxide or alumina or both and coating said first slurry on a first portion of the substrate. The second zone is obtained by preparing a second slurry comprising platinum supported on the ceria-alumina composite; and coating said second slurry on a second portion of the substrate. The top washcoat is prepared by depositing a third slurry comprising rhodium supported on the alumina or ceria-alumina composite on the bottom coat. In the next step, the substrate is subjected to calcination at a temperature ranging from 400 to 700° C. The preparation of catalytic article involves impregnating a support material in particulate form with an active metal solution, such as palladium, platinum/and or rhodium precursor solution. As used herein, “impregnated” or “impregnation” refers to permeation of the catalytic material into the porous structure of the support material. The techniques used to perform impregnation or preparing slurry include incipient wetness impregnation technique (A); co-precipitation technique (B) and co-impregnation technique (C).

Incipient wetness impregnation techniques, also called capillary impregnation or dry impregnation are commonly used for the synthesis of heterogeneous materials, i.e., catalysts. Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Ru(NO)3 and salts thereof), rhodium acetate, or combinations thereof where rhodium is the active metal and palladium nitrate, palladium tetra amine, palladium acetate, or combinations thereof where palladium is the active metal. Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 min to 3 hours. The above process can be repeated as needed to reach the desired level of active metal impregnation.

### Substrate Coating:

The above-noted catalyst compositions are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, colloidal zirconia, or zirconium hydroxide, associative thickeners, and/or surfactants (including anionic, cationic, non-ionic, or amphoteric surfactants). Other exemplary binders include boehmite, gamma-alumina, or delta/theta alumina, as well as silica sol. When present, the binder is typically used in an amount of about 1-5 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3 to 12. The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D₉₀ particle size of about 10 to about 40 microns, preferably 10 to about 30 microns, more preferably about 10 to about 15 microns. The D₉₀ is determined using a dedicated particle size analyzer. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. E.g. the catalyst substrate is dipped one or more times in the slurry or otherwise coated with the slurry. Thereafter, the coated substrate is dried at an elevated temperature (e.g., 100-150° C.) for a period of time (e.g., 10 min-3 hours) and then calcined by heating, e.g., at 400-700° C., typically for about 10 minutes to about 3 hours. Following drying and calcining, the final washcoat coating layer is viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

The coated substrate can be aged, by subjecting the coated substrate to heat treatment. E.g. aging is done at a temperature of about 850° C. to about 1050° C. in the presence of steam under gasoline engine exhaust conditions for 50-300 hours. Aged catalyst articles are thus provided according to present invention. The effective support material such asceria-alumina composites maintains a high percentage (e.g., about 50-100%) of their pore volumes upon aging (e.g., at about 850° C. to about 1050° C. in the presence of steam for about 5-300 hours aging).

### Emission Treatment System:

In another aspect of the present invention, there is also provided an exhaust gas treatment system for internal combustion engines, said system comprising the catalytic article described hereinabove. In one illustration, the system comprises the catalytic article according to the presently claimed invention and an additional a platinum group metal based three-way conversion (TWC) catalytic article. The catalytic article of the present invention may be placed in a close-coupled position. Close-coupled catalysts are placed close to an engine to enable them to reach reaction temperatures as soon as possible. In general, the close-coupled catalyst is placed within three feet, more specifically, within one foot of the engine, and even more specifically, less than six inches from the engine. Close-coupled catalysts are often attached directly to the exhaust gas manifold. Due to their proximity to the engine, close-coupled catalysts are required to be stable at high temperatures. The catalytic article of the invention can also be used as part of an integrated exhaust system comprising one or more additional components for the treatment of exhaust gas emissions. For example, the exhaust system also known as emission treatment system may further comprise a close coupled TWC catalyst, an underfloor TWC catalyst, a catalysed soot filter (CSF) component, and/or a selective catalytic reduction (SCR) catalytic article. The preceding list of components is merely illustrative and should not be taken as limiting the scope of the invention.

In another aspect of the present invention, there is also provided a method of treating a gaseous exhaust stream comprising hydrocarbons, carbon monoxide, and nitrogen oxide, the method comprising contacting said exhaust stream with the catalytic article according to the present invention or the exhaust gas treatment system according to the present invention. The present invention also provides a method of reducing hydrocarbons, carbon monoxide, and nitrogen oxide levels in a gaseous exhaust stream, the method comprising contacting a gaseous exhaust stream with the catalytic article according to the present invention or the exhaust gas treatment system according to the present invention to reduce the levels of hydrocarbons, carbon monoxide, and nitrogen oxide in the exhaust gas.

In another aspect of the present invention, there is also provided use of the catalytic article or the exhaust gas treatment system according to the presently claimed invention for purifying a gaseous exhaust stream comprising hydrocarbons, carbon monoxide, and nitrogen oxide.

The invention is further described by the following embodiments. The features of each of the embodiments are combinable with any of the other embodiments where appropriate and practical.

### Embodiment 1

The presently claimed invention provides a catalytic article comprising a substrate; a bottom washcoat deposited on the substrate; and a top washcoat deposited on the bottom coat, wherein the bottom washcoat comprises a zoned configuration, wherein the zoned configuration comprises a first zone and a second zone, wherein the first zone comprises palladium supported on ceria-zirconia mixed oxide or alumina or both, wherein the second zone comprises platinum supported on a ceria-alumina composite, wherein the top washcoat comprises rhodium supported on an alumina or a ceria-alumina composite.

### Embodiment 2

The catalytic article according to the presently claimed invention, wherein the second zone further comprises palladium supported on ceria-zirconia mixed oxide, wherein the top washcoat comprises rhodium supported on the ceria-alumina composite.

### Embodiment 3

The catalytic article according to the presently claimed invention, wherein the first zone further comprises platinum supported on a ceria-alumina composite, wherein the second zone further comprises palladium supported on ceria-zirconia mixed oxide.

### Embodiment 4

The catalytic article according to the presently claimed invention, wherein the first zone comprises palladium supported on the ceria-zirconia mixed oxide or alumina or both, wherein the second zone comprises platinum supported on the ceria-alumina composite, wherein the top washcoat comprises rhodium supported on the alumina or ceria-alumina composite; and platinum supported on the ceria-alumina composite.

### Embodiment 5

The catalytic article according to the presently claimed invention, wherein the first zone comprises palladium supported on each of the ceria-zirconia mixed oxide and alumina.

### Embodiment 6

The catalytic article according to the presently claimed invention, wherein the first zone covers 10 to 90% of the entire substrate length from an inlet, wherein the second zone covers 10 to 90% of the entire substrate length from an outlet, wherein the top washcoat covers the 10 to 100% of the entire bottom washcoat length from the inlet.

### Embodiment 7

The catalytic article according to the presently claimed invention, wherein the first zone covers 30 to 50% of the entire substrate length from an inlet and the second zone covers 50 to 70% of the entire substrate length from an outlet.

### Embodiment 8

The catalytic article according to the presently claimed invention, wherein the amount of ceria-zirconia mixed oxide in the first zone is higher than the amount of ceria-zirconia mixed oxide in the second zone.

### Embodiment 9

The catalytic article according to the presently claimed invention, wherein the weight ratio of the ceria-zirconia mixed oxide in the first zone to the ceria-zirconia mixed oxide in the second zone is 1.1:1.0 to 1.5:1.

### Embodiment 10

The catalytic article according to the presently claimed invention, wherein the alumina present in the first zone and/or top washcoat is doped with a dopant selected from barium, lanthana, zirconia, neodymian, yttria or titania, wherein the amount of the dopant is 1.0 to 30 wt. % based on the total weight of alumina and dopant.

### Embodiment 11

The catalytic article according to the presently claimed invention, wherein the alumina present in the first zone and/or top washcoat is selected from alumina, lanthana-alumina, titania-alumina, baria-alumina, baria-lanthana-alumina, baria-lanthana-neodymia-alumina, or any combination thereof.

### Embodiment 12

The catalytic article according to the presently claimed invention, wherein the amount of ceria in the ceria-alumina composite present in the top and/or bottom washcoat is 5.0 to 30 wt. %, based on the total weight of the ceria-alumina composite.

### Embodiment 13

The catalytic article according to the presently claimed invention, wherein the first zone comprises palladium supported on the ceria-zirconia mixed oxide or alumina or both in an amount of 50 to 100 wt. %, based on the total weight of palladium in the washcoats, wherein the second zone comprises platinum supported on the ceria-alumina composite in an amount of 50 to 100 wt. %, based on the total weight of platinum in the washcoats, wherein the second zone further comprises 0 to 50 wt. % of palladium supported on the ceria-zirconia mixed oxide, based on the total weight of the palladium in washcoats, wherein the first zone further comprises platinum supported on the ceria-alumina composite in an amount of 0 to 50 wt. %, based on the total weight of platinum in the washcoats.

### Embodiment 14

The catalytic article according to the presently claimed invention, wherein the first zone comprises palladium supported on the ceria-zirconia mixed oxide or alumina or both in an amount of 75 to 100 wt. %, based on the total weight of palladium in the washcoats, wherein the second zone comprises platinum supported on the ceria-alumina composite in an amount of 75 to 100 wt. %, based on the total weight of platinum in the washcoats.

### Embodiment 15

The catalytic article according to the presently claimed invention, wherein the bottom washcoat comprises platinum supported on the ceria-alumina composite in an amount of 50 to 100 wt. %, based on the total weight of platinum in the washcoats and the top washcoat comprises platinum supported on the ceria-alumina composite in an amount of 0 to 50 wt. %, based on the total weight of platinum in the washcoats.

### Embodiment 16

The catalytic article according to the presently claimed invention, wherein the amount of palladium is in the range of 0.02 to 2 wt. %, based on the total weight of the washcoats, the amount of platinum is in the range of 0.02 to 2 wt. %, based on the total weight of the washcoats, and the amount of rhodium is in the range of 0.01 to 0.5 wt. %, based on the total weight of the washcoats.

### Embodiment 17

The catalytic article according to the presently claimed invention, wherein the weight proportion of palladium to platinum in the catalytic article is 9:1 to 1:13.

### Embodiment 18

The catalytic article according to the presently claimed invention, wherein the weight proportion of palladium to platinum in the catalytic article is 3:1 to 1:1.

### Embodiment 19

The catalytic article according to the presently claimed invention, wherein the ceria, calculated as CeO₂ of the ceria-alumina composite present in the top and/or bottom washcoat is 1.0 to 50 wt. %, based on the total weight of the ceria-alumina composite, preferably, the ceria, calculated as CeO₂ in the ceria-alumina composite present in the top and/or bottom washcoat is 5.0 to 50 wt. %, based on the total weight of the ceria-alumina composite, more preferably, the ceria, calculated as CeO₂ in the ceria-alumina composite present in the top and/or bottom washcoat is 5 to 30 wt. %, based on the total weight of the ceria-alumina composite, even more preferably, the ceria, calculated as CeO₂ in the ceria-alumina composite present in the top and/or bottom washcoat is 8 to 20 wt. %, based on the total weight of the ceria-alumina composite.

### Embodiment 20

The catalytic article according to the presently claimed invention, wherein the ceria-zirconia mixed oxide comprises ceria, calculated as CeO₂ in an amount of about 20 to 50 wt. %, based on the total weight of the ceria-zirconia mixed oxide; and zirconia, calculated as ZrO₂ in an amount of about 40 to about 80 wt. %, based on the total weight the ceria-zirconia mixed oxide.

### Embodiment 21

The catalytic article according to the presently claimed invention, wherein the ceria-zirconia mixed oxide comprises a dopant selected from lanthana, titania, hafnia, magnesia, calcia, strontia, baria, yttrium, hafnium, praseodymium, neodymium, or any combinations thereof.

### Embodiment 22

The catalytic article according to the presently claimed invention, wherein the substrate is selected from a ceramic substrate, a metal substrate, a ceramic foam substrate, a polymer foam substrate, or a woven fibre substrate.

### Embodiment 23

The catalytic article according to the presently claimed invention, wherein the amount ceria-zirconia mixed oxide is in the range of 10 to 90 wt. %, based on the total weight of the washcoats, wherein the amount of the alumina is in the range of 5.0 to 99 wt. %, based on the total weight of the washcoats, wherein the amount of the ceria-alumina composite is in the range of 10 to 80 wt. %, based on the total weight of the washcoats.

### Embodiment 24

The catalytic article according to the presently claimed invention, wherein the catalytic article comprising a substrate; a bottom washcoat deposited on the substrate; and a top washcoat deposited on the bottom coat, wherein the bottom washcoat comprises a zoned configuration, wherein the zoned configuration comprises a first zone and a second zone, wherein the first zone covers 30 to 50% of the entire substrate length from an inlet and the second zone covers 50 to 70% of the entire substrate length from an outlet, wherein the first zone comprises palladium impregnated onto the alumina and the ceria-zirconia mixed oxide in an amount of 75 to 100 wt. %, based on the total weight of palladium in the washcoats, wherein the second zone comprises platinum impregnated onto the ceria-alumina composite and palladium impregnated onto the ceria-zirconia mixed oxide, wherein the top washcoat comprises rhodium supported on the ceria-alumina composite, wherein the weight proportion of palladium to platinum in the catalytic article is 3:1 to 1:1.

### Embodiment 25

A catalytic article comprising a substrate; a bottom washcoat deposited on the substrate; and a top washcoat deposited on the bottom coat, wherein the bottom washcoat comprises a zoned configuration, wherein the zoned configuration comprises a first zone and a second zone, wherein the first zone covers 30 to 50% of the entire substrate length from an inlet and the second zone covers 50 to 70% of the entire substrate length from an outlet, wherein the first zone comprises palladium impregnated onto the alumina and the stabilized ceria-zirconia mixed oxide in an amount of 75 to 100 wt. %, based on the total weight of palladium in the washcoats, wherein the second zone comprises platinum impregnated onto the ceria-alumina composite and palladium impregnated onto the stabilized ceria-zirconia mixed oxide, wherein the top washcoat comprises rhodium supported on the ceria-alumina composite, wherein the weight proportion of palladium to platinum in the catalytic article is 3:1 to 1:1, wherein the amount of the ceria-zirconia mixed oxide in the first zone is higher than the amount of ceria-zirconia mixed oxide in the second zone.

### Embodiment 26

A catalytic article comprising a substrate; a bottom washcoat deposited on the substrate; and a top washcoat deposited on the bottom coat, wherein the bottom washcoat comprises a zoned configuration, wherein the zoned configuration comprises a first zone and a second zone, wherein the first zone covers 30 to 50% of the entire substrate length from an inlet and the second zone covers 50 to 70% of the entire substrate length from an outlet, wherein the first zone consists of palladium impregnated onto the alumina and the stabilized ceria-zirconia mixed oxide in an amount of 75 to 100 wt. %, based on the total weight of palladium in the washcoats, wherein the second zone consists of platinum impregnated onto the ceria-alumina composite and palladium impregnated onto the stabilized ceria-zirconia mixed oxide, wherein the top washcoat consist of rhodium supported on the ceria-alumina composite.

### Embodiment 27

A catalytic article comprising a substrate; a bottom washcoat deposited on the substrate; and a top washcoat deposited on the bottom coat, wherein the bottom washcoat comprises a zoned configuration, wherein the zoned configuration comprises a first zone and a second zone, wherein the first zone covers 30 to 50% of the entire substrate length from an inlet and the second zone covers 50 to 70% of the entire substrate length from an outlet, wherein the first zone consists of palladium impregnated onto the alumina and the stabilized ceria-zirconia mixed oxide in an amount of 75 to 100 wt. %, based on the total weight of palladium in the washcoats, wherein the second zone consists of platinum impregnated onto the ceria-alumina composite and palladium impregnated onto the stabilized ceria-zirconia mixed oxide, wherein the top washcoat consist of rhodium supported on the ceria-alumina composite, wherein the weight proportion of palladium to platinum in the catalytic article is 3:1 to 1:1, wherein the amount of the ceria-zirconia mixed oxide in the first zone is higher than the amount of ceria-zirconia mixed oxide in the second zone.

### Embodiment 28

A catalytic article comprising a substrate; a bottom washcoat deposited on the substrate; and a top washcoat deposited on the bottom coat, wherein the bottom washcoat comprises a zoned configuration, wherein the zoned configuration comprises a first zone and a second zone, wherein the first zone covers 30 to 50% of the entire substrate length from an inlet and the second zone covers 50 to 70% of the entire substrate length from an outlet, wherein the first zone consists of palladium impregnated onto the alumina and the stabilized ceria-zirconia mixed oxide in an amount of 75 to 100 wt. %, based on the total weight of palladium in the washcoats, wherein the second zone consists of platinum impregnated onto the ceria-alumina composite and palladium impregnated onto the stabilized ceria-zirconia mixed oxide, wherein the top washcoat consist of rhodium and platinum supported on the ceria-alumina composite, wherein the weight proportion of palladium to platinum in the catalytic article is 3:1 to 1:1, wherein the amount of the ceria-zirconia mixed oxide in the first zone is higher than the amount of ceria-zirconia mixed oxide in the second zone.

Aspects of the presently claimed invention are more fully illustrated by the following examples, which are set forth to illustrate certain aspects of the present invention and are not to be construed as limiting thereof.

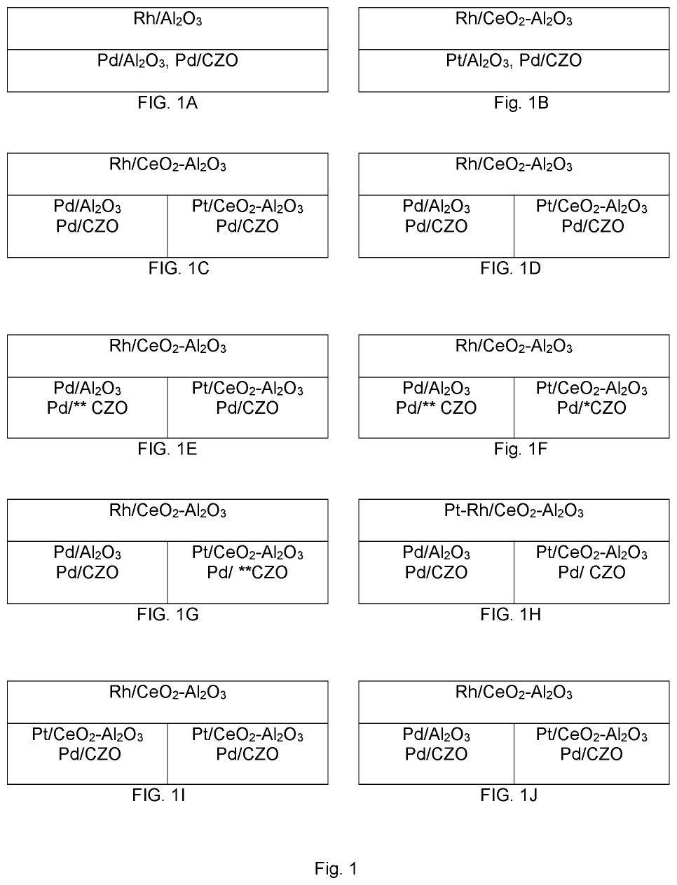

All catalytic articles were coated onto a cylindrical monolith cordierite substrate having dimensions of 4.66″ in diameter and 3.81″ in length, a cell density of 800 cpsi, and a wall thickness of 2.5 mils. The washcoat architectures of examples are plotted in FIG. 1. The designs and PGM allocations of non-zoned references and zoned catalytic articles are summarized in Tables 1 and 2, respectively.

TABLE 1
Designs and PGM allocations of non-zoned reference catalytic articles*

| | Catalytic Article | | Bottom Layer | | | Top Layer | | |
|---|---|---|---|---|---|---|---|---|
| | PGM | Pt/Pd/Rh | PGM | Pt/Pd/Rh | CZO | PGM | Pt/Pd/Rh | CZO |
| Example | g/ft³ | Wt. Ratio | g/ft³ | Wt. Ratio | g/in³ | g/ft³ | Wt. Ratio | g/in³ |
| 1 | 120 | 0/118/2 | 118 | 0/118/0 | 1.30 | 2 | 0/0/2 | 0.15 |
| 2 | 120 | 59/59/2 | 118 | 59/59/2 | 1.40 | 2 | 0/0/2 | 0.15 |

*CZO: Ceria-zirconia mixed oxides

TABLE 2
Designs and PGM allocations of zoned catalytic articles

| | Catalytic Article | | Inlet Zone of Bottom Layer | | | | Outlet Zone of Bottom Layer | | | | Top Layer | | | |
|---|---|---|---|---|---|---|---|---|---|---|---|---|---|---|
| | PGM | Pt/Pd/Rh | Length | PGM | Pt/Pd/Rh | CZO* | Length | PGM | Pt/Pd/Rh | CZO* | Length | PGM | Pt/Pd/Rh | CZO* |
| Example | g/ft³ | Wt. Ratio | % | g/ft³ | Wt. Ratio | g/in³ | % | g/ft³ | Wt. Ratio | g/in³ | % | g/ft³ | Wt. Ratio | g/in³ |
| 3 | 120 | 29.5/88.5/2 | 50 | 118 | 0/118/0 | 1.40 | 50 | 118 | 59/59/0 | 1.40 | 100 | 2 | 0/0/2 | 0.15 |
| 4 | 120 | 59/59/2 | 50 | 106.2 | 0/106.2/0 | 1.40 | 50 | 129.8 | 118/11.8/0 | 1.40 | 100 | 2 | 0/0/2 | 0.15 |
| 5 | 120 | 59/59/2 | 50 | 106.2 | 0/106.2/0 | 1.60 | 50 | 129.8 | 118/11.8/0 | 1.40 | 100 | 2 | 0/0/2 | 0.15 |
| 6 | 120 | 59/59/2 | 50 | 118 | 0/106.2/0 | 1.80 | 50 | 129.8 | 118/11.8/0 | 1.20 | 100 | 2 | 0/0/2 | 0.15 |
| 7 | 120 | 59/59/2 | 50 | 106.2 | 0/106.2/0 | 1.40 | 50 | 129.8 | 118/11.8/0 | 1.65 | 100 | 2 | 0/0/2 | 0.15 |
| 8 | 120 | 59/59/2 | 50 | 106.2 | 0/106.2/0 | 1.40 | 50 | 100.3 | 88.5/11.8/0 | 1.40 | 100 | 16.75 | 14.75/0/2 | 0.15 |
| 9 | 120 | 59/59/2 | 50 | 165.2 | 59/106.2/0 | 1.40 | 50 | 70.8 | 59/11.8/0 | 1.40 | 100 | 2 | 0/0/2 | 0.15 |
| 10 | 120 | 59/59/2 | 40 | 110.6 | 0/110.6/0 | 1.40 | 60 | 132.9 | 98.4/24.6 | 1.40 | 100 | 2 | 0/0/2 | 0.15 |

*CZO: Ceria-zirconia mixed oxide.
Length: Percentage of the washcoat coverage as a function of the substrate length.

### Comparative Example 1: Preparation of a Non-Zoned Bilayer Pd/Rh Reference Catalytic Article (FIG. 1A) with a PGM Loading of 120 g/Ft³ (Pt/Pd/Rh=0/118/2

Bottom Layer: This layer covers 100% of the substrate length with a PGM loading of 118 g/ft³ (Pt/Pd/Rh=0/118/0). 59 g/ft³ of Pd (50 wt. % of the total Pd) in the form of palladium nitrate was impregnated onto an alumina, and 59 g/ft³ of Pd (50 wt. % of the total Pd) in the form of palladium nitrate was impregnated onto a ceria-zirconia mixed oxide with approximately 40 wt. % ceria. A slurry containing about 34.4 wt. % of the alumina, 49.6 wt. % of the ceria-zirconia mixed oxide, barium acetate to yield 11.5 wt. % of BaO, zirconium acetate to yield 1.9 wt. % of ZrO₂, and 2.62 wt. % of Pd was coated onto the substrate. The washcoat loading of the bottom layer was about 2.61 g/in³ after calcination at 550° C. for 1 hour in air.

Top Layer: This layer covers 100% of the substrate length with a PGM loading of 2 g/ft³ (Pt/Pd/Rh=0/0/2). 2 g/ft³ of Rh (100 wt. % of the total Rh) in the form of rhodium nitrate was impregnated onto an alumina. A slurry mixture containing about 84.9 wt. % of the alumina, 15.0 wt. % of a ceria-zirconia mixed oxide with approximately 50 wt. % ceria, and 0.12 wt. % of Rh was coated over the bottom layer. The washcoat loading of the top layer was about 1.00 g/in³ after calcination at 550° C. for 1 hour in air.

### Comparative Example 2: Preparation of a Non-Zoned Bilayer Pt/Pd/Rh Reference Catalytic Article (FIG. 1B) with a PGM Loading of 120 g/Ft³ (Pt/Pd/Rh=59/59/2

Bottom Layer: This layer covers 100% of the substrate length with a PGM loading of 118 g/ft³ (Pt/Pd/Rh=59/59/0). 59 g/ft³ of Pt (100 wt. % of the total Pt) in the form of a platinum-amine complex was impregnated onto the alumina. 59 g/ft³ of Pd (100 wt. % of the total Pd) in the form of palladium nitrate was impregnated onto a ceria-zirconia mixed oxide with approximately 40 wt. % ceria. A slurry containing about 33.1 wt. % of the alumina, 54.5 wt. % of the ceria-zirconia mixed oxide, barium acetate to yield 7.8 wt. % of BaO, zirconium acetate to yield 1.9 wt. % of ZrO₂, 1.33 wt. % of Pt, and 1.33 wt. % of Pd was coated onto the substrate. The washcoat loading of the bottom layer was about 2.57 g/in³ after calcination at 550° C. for 1 hour in air.

Top Layer: This layer covers 100% of the substrate length with a PGM loading of 2 g/ft³ (Pt/Pd/Rh=0/0/2). 2 g/ft³ of Rh (100 wt. % of the total Rh) in the form of rhodium nitrate was impregnated onto a ceria-alumina composite with approximately 10 wt. % ceria. A slurry mixture containing about 84.9 wt. % of the ceria-alumina, 15.0 wt. % of a ceria-zirconia mixed oxide with approximately 50 wt. % ceria, and 0.12 wt. % of Rh was coated over the bottom layer. The washcoat loading of the top layer was about 1.00 g/in³ after calcination at 550° C. for 1 hour in air.

### Example 3: Preparation of a Zoned Bilayer Pt/Pd/Rh Catalytic Article (FIG. 1C) with a PGM Loading of 120 g/Ft³ (Pt/Pd/Rh=29.5/88.5/2

Inlet Zone of Bottom Layer: This zone covers 50% of the substrate length from inlet to middle with a PGM loading of 118 g/ft³ (Pt/Pd/Rh=0/118/0). 59 g/ft³ of Pd (33.3 wt. % of the total Pd) in the form of palladium nitrate was impregnated onto an alumina, and 59 g/ft³ of Pd (33.3 wt. % of the total Pd) in the form of palladium nitrate was impregnated onto a ceria-zirconia mixed oxide with approximately 40 wt. % ceria. A slurry containing about 33.1 wt. % of the alumina, 54.5 wt. % of the ceria-zirconia mixed oxide, barium acetate to yield 7.8 wt. % of BaO, zirconium acetate to yield 1.9 wt. % of ZrO₂, and 2.66 wt. % of Pd was coated onto the substrate. The washcoat loading of the inlet zoned of the bottom layer was about 2.57 g/in³ after calcination at 550° C. for 1 hour in air.

Outlet Zone of Bottom Layer: This zone covers 50% of the substrate length from outlet to middle with a PGM loading of 118 g/ft³ (Pt/Pd/Rh=59/59/0). 59 g/ft³ of Pt (100 wt. % of the total Pt) in the form of a platinum-amine complex was impregnated onto a ceria-alumina composite with approximately 10 wt. % ceria. 59 g/ft³ of Pd (33.3 wt. % of the total Pd) in the form of palladium nitrate was impregnated onto a ceria-zirconia mixed oxide with approximately 40 wt. % ceria. A slurry containing about 33.1 wt. % of the ceria-alumina composite, 54.5 wt. % of the ceria-zirconia mixed oxide, barium acetate to yield 7.8 wt. % of BaO, a colloidal alumina binder to yield 1.9 wt. % of Al₂O₃, 1.33 wt. % of Pt, and 1.33 wt. % of Pd was coated onto the substrate. The washcoat loading of the outlet zone of the bottom layer was about 2.57 g/in³ after calcination at 550° C. for 1 hour in air.

Top Layer: The same to the top layer of Example 2.

### Example 4: Preparation of a Zoned Bilayer Pt/Pd/Rh Catalytic Article (FIG. 1D) with a PGM Loading of 120 g/Ft³ (Pt/Pd/Rh=59/59/2

Inlet Zone of Bottom Layer: This zone covers 50% of the substrate length from inlet to middle with a PGM loading of 106.2 g/ft³ (Pt/Pd/Rh=0/106.2/0). 53.1 g/ft³ of Pd (45 wt. % of the total Pd) in the form of palladium nitrate was impregnated onto an alumina, and 53.1 g/ft³ of Pd (45 wt. % of the total Pd) in the form of palladium nitrate was impregnated onto a ceria-zirconia mixed oxide with approximately 40 wt. % ceria. A slurry containing about 33.2 wt. % of the alumina, 54.7 wt. % of the ceria-zirconia mixed oxide, barium acetate to yield 7.8 wt. % of BaO, zirconium acetate to yield 2.0 wt. % of ZrO₂, and 2.40 wt. % of Pd was coated onto the substrate. The washcoat loading of the inlet zone of the bottom layer was about 2.56 g/in³ after calcination at 550° C. for 1 hour in air.

Outlet Zone of Bottom Layer: This zone covers 50% of the substrate length from outlet to middle with a PGM loading of 129.8 g/ft³ (Pt/Pd/Rh=118/11.8/0). 118 g/ft³ of Pt (100 wt. % of the total Pt) in the form of a platinum-amine complex was impregnated onto a ceria-alumina composite with approximately 10 wt. % ceria. 11.8 g/ft³ of Pd (10 wt. % of the total Pd) in the form of palladium nitrate was impregnated onto a ceria-zirconia mixed oxide with approximately 40 wt. % ceria. A slurry containing about 33.1 wt. % of the ceria-alumina composite, 54.5 wt. % of the ceria-zirconia mixed oxide, barium acetate to yield 7.8 wt. % of BaO, a colloidal alumina binder to yield 1.9 wt. % of Al₂O₃, 2.65 wt. % of Pt, and 0.26 wt. % of Pd was coated onto the substrate. The washcoat loading of the outlet zone of the bottom layer was about 2.58 g/in³ after calcination at 550° C. for 1 hour in air.

Top Layer: The same to the top layer of Example 2.

### Example 5: Preparation of a Zoned Bilayer Pt/Pd/Rh Catalytic Article (FIG. 1E) with a PGM Loading of 120 g/Ft³ (Pt/Pd/Rh=59/59/2), and with an Increased (Shown as **) Ceria-Zirconia Loading (1.6 g/In³ in Example 5 vs. 1.4 g/In³ in Example 4) in the Inlet Zone of the Bottom Layer

Inlet Zone of Bottom Layer: This zone covers 50% of the substrate length from inlet to middle with a PGM loading of 106.2 g/ft³ (Pt/Pd/Rh=0/106.2/0). 53.1 g/ft³ of Pd (45 wt. % of the total Pd) in the form of palladium nitrate was impregnated onto an alumina, and 53.1 g/ft³ of Pd (45 wt. % of the total Pd) in the form of palladium nitrate was impregnated onto a ceria-zirconia mixed oxide with approximately 40 wt. % ceria. A slurry containing about 25.4 wt. % of the alumina, 62.5 wt. % of the ceria-zirconia mixed oxide, barium acetate to yield 7.8 wt. % of BaO, zirconium acetate to yield 2.0 wt. % of ZrO₂, and 2.40 wt. % of Pd was coated onto the substrate. The washcoat loading of the inlet zone of the bottom layer was about 2.56 g/in³ after calcination at 550° C. for 1 hour in air.

Outlet Zone of Bottom Layer: The same to the outlet zone of the bottom layer of Example 4.

Top Layer: The same to the top layer of Example 2.

### Example 6: Preparation of a Zoned Bilayer Pt/Pd/Rh Catalytic Article (FIG. 1F) with a PGM Loading of 120 g/Ft³ (Pt/Pd/Rh=59/59/2), with a Further Increased (Shown as **) Ceria-Zirconia Loading (1.8 g/In³ in Example 6 vs. 1.4 g/In³ in Example 4) in the Inlet Zone of the Bottom Layer and Decreased (Shown as *) Ceria-Zirconia Loading (1.2 g/In³ in Example 6 vs. 1.4 g/In³ in Example 4) in the Outlet Zone of the Bottom Layer

Inlet Zone of Bottom Layer: This zone covers 50% of the substrate length from inlet to middle with a PGM loading of 106.2 g/ft³ (Pt/Pd/Rh=0/106.2/0). 53.1 g/ft³ of Pd (45 wt. % of the total Pd) in the form of palladium nitrate was impregnated onto an alumina, and 53.1 g/ft³ of Pd (45 wt. % of the total Pd) in the form of palladium nitrate was impregnated onto a ceria-zirconia mixed oxide with approximately 40 wt. % ceria. A slurry containing about 17.6 wt. % of the alumina, 70.3 wt. % of the ceria-zirconia mixed oxide, barium acetate to yield 7.8 wt. % of BaO, zirconium acetate to yield 2.0 wt. % of ZrO₂, and 2.40 wt. % of Pd was coated onto the substrate. The washcoat loading of the inlet zone of the bottom layer was about 2.56 g/in³ after calcination at 550° C. for 1 hour in air.

Outlet Zone of Bottom Layer: This zone covers 50% of the substrate length from outlet to middle with a PGM loading of 129.8 g/ft³ (Pt/Pd/Rh=118/11.8/0). 118 g/ft³ of Pt (100 wt. % of the total Pt) in the form of a platinum-amine complex was impregnated onto a ceria-alumina composite with approximately 10 wt. % ceria. 11.8 g/ft³ of Pd (10 wt. % of the total Pd) in the form of palladium nitrate was impregnated onto a ceria-zirconia mixed oxide with approximately 40 wt. % ceria. A slurry containing about 40.8 wt. % of the ceria-alumina composite, 46.6 wt. % of the ceria-zirconia mixed oxide, barium acetate to yield 7.8 wt. % of BaO, a colloidal alumina binder to yield 1.9 wt. % of Al₂O₃, 2.65 wt. % of Pt, and 0.26 wt. % of Pd was coated onto the substrate. The washcoat loading of the outlet zone of the bottom layer was about 2.58 g/in³ after calcination at 550° C. for 1 hour in air.

Top Layer: The same to the top layer of Example 2.

### Example 7: Preparation of a Zoned Bilayer Pt/Pd/Rh Catalytic Article (FIG. 1G) with a PGM Loading of 120 g/Ft³ (Pt/Pd/Rh=59/59/2), and with an Increased Ceria-Zirconia Loading (Shown as *) (1.65 g/In³ in Example 7 vs. 1.4 g/In³ in Example 4) in the Outlet Zone of the Bottom Layer

Inlet Zone of Bottom Layer: The same to the inlet zone of the bottom layer of Example 4.

Outlet Zone of Bottom Layer: This zone covers 50% of the substrate length from outlet to middle with a PGM loading of 129.8 g/ft³ (Pt/Pd/Rh=118/11.8/0). 118 g/ft³ of Pt (100 wt. % of the total Pt) in the form of a platinum-amine complex was impregnated onto a ceria-alumina composite with approximately 30 wt. % ceria. 11.8 g/ft³ of Pd (10 wt. % of the total Pd) in the form of palladium nitrate was impregnated onto a ceria-zirconia mixed oxide with approximately 40 wt. % ceria. A slurry containing about 23.3 wt. % of the ceria-alumina composite, 64.1 wt. % of the ceria-zirconia mixed oxide, barium acetate to yield 7.8 wt. % of BaO, a colloidal alumina binder to yield 1.9 wt. % of Al₂O₃, 2.65 wt. % of Pt, and 0.26 wt. % of Pd was coated onto the substrate. The washcoat loading of the outlet zone of the bottom layer was about 2.58 g/in³ after calcination at 550° C. for 1 hour in air.

Top Layer: The same to the top layer of Example 2.

### Example 8: Preparation of a Zoned Bilayer Pt/Pd/Rh Catalytic Article (FIG. 1H) with a PGM Loading of 120 g/Ft³ (Pt/Pd/Rh=59/59/2), and with 25 wt. % of Pt Allocated to the Top Layer

Inlet Zone of Bottom Layer: This zone covers 50% of the substrate length from inlet to middle with a PGM loading of 106.2 g/ft³ (Pt/Pd/Rh=0/106.2/0). 53.1 g/ft³ of Pd (45 wt. % of the total Pd) in the form of palladium nitrate was impregnated onto an alumina, and 53.1 g/ft³ of Pd (45 wt. % of the total Pd) in the form of palladium nitrate was impregnated onto a ceria-zirconia mixed oxide with approximately 40 wt. % ceria. A slurry containing about 26.0 wt. % of the alumina, 60.6 wt. % of the ceria-zirconia mixed oxide, barium acetate to yield 8.7 wt. % of BaO, zirconium acetate to yield 2.2 wt. % of ZrO₂, and 2.66 wt. % of Pd was coated onto the substrate. The washcoat loading of the inlet zone of the bottom layer was about 2.31 g/in³ after calcination at 550° C. for 1 hour in air.

Outlet Zone of Bottom Layer: This zone covers 50% of the substrate length from outlet to middle with a PGM loading of 100.3 g/ft³ (Pt/Pd/Rh=88.5/11.8/0). 88.5 g/ft³ of Pt (75 wt. % of the total Pt) in the form of a platinum-amine complex was impregnated onto a ceria-alumina composite with approximately 10 wt. % ceria. 11.8 g/ft³ of Pd (10 wt. % of the total Pd) in the form of palladium nitrate was impregnated onto a ceria-zirconia mixed oxide with approximately 40 wt. % ceria. A slurry containing about 26.0 wt. % of the ceria-alumina composite, 60.7 wt. % of the ceria-zirconia mixed oxide, barium acetate to yield 8.7 wt. % of BaO, a colloidal alumina binder to yield 2.2 wt. % of Al₂O₃, 2.22 wt. % of Pt, and 0.30 wt. % of Pd was coated onto the substrate. The washcoat loading of the outlet zone of the bottom layer was about 2.31 g/in³ after calcination at 550° C. for 1 hour in air.

Top Layer: This layer covers 100% of the substrate length with a PGM loading of 16.75 g/ft³ (Pt/Pd/Rh=14.75/0/2). 14.75 g/ft³ of Pt (25 wt. % of the total Pt) in the form of a platinum-amine complex and 2 g/ft³ of Rh (100 wt. % of the total Rh) in the form of rhodium nitrate were sequentially impregnated onto a ceria-alumina composite with approximately 10 wt. % ceria. A slurry mixture containing about 88.3 wt. % of the ceria-alumina, 11.1 wt. % of binder, 0.63 wt. % of Pt, and 0.085 wt. % of Rh was coated over the bottom layer. The washcoat loading of the top layer was about 1.36 g/in³ after calcination at 550° C. for 1 hour in air.

### Example 9: Preparation of a Zoned Bilayer Pt/Pd/Rh Catalytic Article (FIG. 1I) with a PGM Loading of 120 g/Ft³ (Pt/Pd/Rh=59/59/2

Inlet Zone of Bottom Layer: This zone covers 50% of the substrate length from inlet to middle with a PGM loading of 165.2 g/ft³ (Pt/Pd/Rh=59/106.2/0). 59 g/ft³ of Pt (50 wt. % of the total Pt) in the form of a platinum-amine complex was impregnated onto a ceria-alumina composite with approximately 10 wt. % ceria. 106.2 g/ft³ of Pd (90 wt. % of the total Pd) in the form of palladium nitrate was impregnated onto a ceria-zirconia mixed oxide with approximately 40 wt. % ceria. A slurry containing about 32.7 wt. % of the ceria-alumina composite, 53.9 wt. % of the ceria-zirconia mixed oxide, barium acetate to yield 7.7 wt. % of BaO, zirconium acetate to yield 1.9 wt. % of ZrO₂, 1.31 wt. % of Pt, and 2.36 wt. % of Pd was coated onto the substrate. The washcoat loading of the inlet zone of the bottom layer was about 2.60 g/in³ after calcination at 550° C. for 1 hour in air.

Outlet Zone of Bottom Layer: This zone covers 50% of the substrate length from outlet to middle with a PGM loading of 70.8 g/ft³ (Pt/Pd/Rh=59/11.8/0). 59 g/ft³ of Pt (50 wt. % of the total Pt) in the form of a platinum-amine complex was impregnated onto a ceria-alumina composite with approximately 10 wt. % ceria. 11.8 g/ft³ of Pd (10 wt. % of the total Pd) in the form of palladium nitrate was impregnated onto a ceria-zirconia mixed oxide with approximately 40 wt. % ceria. A slurry containing about 33.5 wt. % of the ceria-alumina composite, 55.1 wt. % of the ceria-zirconia mixed oxide, barium acetate to yield 7.9 wt. % of BaO, a colloidal alumina binder to yield 2.0 wt. % of Al₂O₃, 1.34 wt. % of Pt, and 0.27 wt. % of Pd was coated onto the substrate. The washcoat loading of the outlet zone of the bottom layer was about 2.54 g/in³ after calcination at 550° C. for 1 hour in air.

Top Layer: The same to the top layer of Example 2.

### Example 10: Preparation of a Zoned Bilayer Pt/Pd/Rh Catalytic Article (FIG. 1J) with a PGM Loading of 120 g/Ft³ (Pt/Pd/Rh=59/59/2

Inlet Zone of Bottom Layer: This zone covers 40% of the substrate length from inlet to middle with a PGM loading of 110.6 g/ft³ (Pt/Pd/Rh=0/110.6/0). 50.3 g/ft³ of Pd (37.5 wt. % of the total Pd) in the form of palladium nitrate was impregnated onto an alumina, and 50.3 g/ft³ of Pd (37.5 wt. % of the total Pd) in the form of palladium nitrate was impregnated onto a ceria-zirconia mixed oxide with approximately 40 wt. % ceria. A slurry containing about 33.2 wt. % of the alumina, 54.6 wt. % of the ceria-zirconia mixed oxide, barium acetate to yield 7.8 wt. % of BaO, zirconium acetate to yield 2.0 wt. % of ZrO₂, and 2.50 wt. % of Pd was coated onto the substrate. The washcoat loading of the inlet zoned of the bottom layer was about 2.56 g/in³ after calcination at 550° C. for 1 hour in air.

Outlet Zone of Bottom Layer: This zone covers 60% of the substrate length from outlet to middle with a PGM loading of 122.9 g/ft³ (Pt/Pd/Rh=98.3/24.6/0). 98.3 g/ft³ of Pt (100 wt. % of the total Pt) in the form of a platinum-amine complex was impregnated onto a ceria-alumina composite with approximately 10 wt. % ceria. 24.6 g/ft³ of Pd (25 wt. % of the total Pd) in the form of palladium nitrate was impregnated onto a ceria-zirconia mixed oxide with approximately 40 wt. % ceria. A slurry containing about 33.1 wt. % of the ceria-alumina composite, 54.5 wt. % of the ceria-zirconia mixed oxide, barium acetate to yield 7.8 wt. % of BaO, a colloidal alumina binder to yield 1.9 wt. % of Al₂O₃, 2.21 wt. % of Pt, and 0.55 wt. % of Pd was coated onto the substrate. The washcoat loading of the outlet zone of the bottom layer was about 2.57 g/in³ after calcination at 550° C. for 1 hour in air.

Top Layer: The same to the top layer of Example 2.

### Aging and Testing

The full-size monolith catalytic articles of Examples 1-10 were mounted in steel converter cans and aged at the close-coupled position in an exhaust pipeline of a gasoline engine which was operated under exothermic aging cycles. The duration of the aging is 83 hours at a maximum bed temperature of about 945° C. The aged catalytic converters were tested at the close-coupled position on a 4-cylinder ULEV-50 gasoline vehicle of a 2 L engine displacement which was operated on the US FTP-75 drive cycle following the certified procedures and tolerances. A conventional TWC catalyst with a PGM loading of 3 g/ft³ (Rh only) was used as the universal underfloor catalytic converter during testing.

Table 3 summarizes the tailpipe emissions of NMHC, NOx and CO acquired from the FTP-75 tests. Examples 1 and 2 are non-zoned bilayer catalytic articles for reference.

TABLE 3
Tailpipe NMHC, NOx, and CO emissions on FTP-75 dive cycle

| | FTP-75 Tailpipe Emissions | | |
|---|---|---|---|
| Example | NMHC, mg/mile | NOx, mg/mile | CO, mg/mile |
| 1 | 14.8 | 8.5 | 635 |
| 2 | 22.6 | 8.8 | 747 |
| 3 | 14.0 | 7.5 | 625 |
| 4 | 16.1 | 7.7 | 631 |
| 5 | 14.6 | 8.3 | 626 |
| 6 | 14.2 | 8.1 | 608 |
| 7 | 18.4 | 8.7 | 760 |
| 8 | 15.6 | 7.4 | 628 |
| 9 | 16.4 | 8.1 | 646 |
| 10 | 16.5 | 7.8 | 668 |

The use of a substantial amount of Pt in Example 2 led to deterioration in NMHC, NOx, and CO emissions. The NMHC emissions of Example 2 increased by about 53% compared to those of Example 1. Examples 3 and 4 are zoned bilayer catalytic articles with 25% and 50% of Pd substituted with Pt relative to Pd/Rh-based Example 1. The zoned catalytic articles have 66.7% to 90% of the total Pd enriched in the inlet zone of the bottom layer covering 50% of the substrate length. All Pt and the remaining Pd were allocated to the outlet zone of the bottom layer covering another 50% of the substrate length, with the Pt deposited on a ceria-alumina composite with about 10% ceria. All Rh was allocated to the top layer covering the whole substrate length. Example 3 exhibited slightly better performance in all three emissions relative to Example 1, indicating the feasibility of using zoned washcoat architecture with enriched Pd in the inlet zone to achieve 25% substitution of Pd with Pt. With the same 50% Pt substitution, Example 4 displayed significantly better performance than Example 2. For instance, the NMHC emissions were reduced from 22.6 for Example 4 to 16.1 mg/mile for example 2. The improved performance of the tailpipe emissions, especially for NMHC, is attributable to the zoned washcoat architecture which allows for the Pd-enrichment in the inlet zone. The Pd-enriched inlet zone promoted NMHC light-off during the engine cold start whereas the Pt-comprising outlet zone performed well under the hot transient conditions. Compared to Example 4, Example 5 increased the CZO loading of the inlet zone of the bottom layer from 1.4 to 1.6 g/in³ while keeping the CZO loading of the outlet zone unchanged. Example 6 further increased the CZO loading of the inlet zone to 1.8 g/in³ and at the same time decreased the CZO loading of the outlet zone from 1.4 to 1.2 g/in³. With the increased CZO loading together with the enriched Pd in the inlet zone, Examples 5 and 6 further improved NMHC performance in comparison with Example 4. The performance of Examples 5 and 6 became comparable to or slightly better than Pd/Rh-based Example 1. These findings indicated the feasibility of using the zoned washcoat architecture with Pd-enrichment and the OSC boost in the inlet zone to achieve 50% substitution of Pd with Pt. Example 7 kept the CZO loading in the inlet zone the same to Example 4 but increased the CZO loading of the outlet zone from 1.4 to 1.65 g/in³. The NMHC emissions increased from 14.6 mg/mile for Example 6 to 18.4 mg/mile for Example 7. Therefore, the OSC boost in the Pd-enriched inlet zone is preferred over the OSC boost in the Pt-enriched outlet zone in terms of performance. These findings are in good agreement with the fact that Pd in general activates CZO better than Pt. It is worthy to mention that in many examples, the invented trimetal catalytic articles displayed slightly to moderately better NOx performance relative to Pd/Rh-based Example 1. Example 8 allocated 25% of Pt to the top layer together with Rh, whereas Example 9 allocated 50% of Pt to the inlet zone of the bottom layer. Example 8 and 9 performed comparably to or better than Example 4, supporting that a portion of Pt can be incorporated to the inlet zone and the top layer without negative effects on catalytic activities. Example 10 has an inlet zone of 40% coverage and an outlet zone of 60% coverage. The performance of Example 10 is comparable to that of Example 4 which has a 50% coverage for the inlet zone and 50% coverage for the outlet zone.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation.

1. A catalytic article comprising:
a) a substrate;
b) a bottom washcoat deposited on the substrate; and
c) a top washcoat deposited on the bottom washcoat,
wherein the bottom washcoat comprises a zoned configuration,
wherein the zoned configuration comprises a first zone and a second zone, wherein the first zone comprises palladium supported on ceria-zirconia mixed oxide or alumina or both, wherein the second zone comprises platinum supported on a ceria-alumina composite, wherein the top washcoat comprises rhodium supported on an alumina or a ceria-alumina composite.

2. The catalytic article according to claim 1, wherein the second zone further comprises palladium supported on ceria-zirconia mixed oxide, wherein the top washcoat comprises rhodium supported on the ceria-alumina composite.

3. The catalytic article according to claim 1, wherein the first zone further comprises platinum supported on a ceria-alumina composite, wherein the second zone further comprises palladium supported on ceria-zirconia mixed oxide.

4. The catalytic article according to claim 1, wherein the first zone comprises palladium supported on the ceria-zirconia mixed oxide or alumina or both, wherein the second zone comprises platinum supported on the ceria-alumina composite, wherein the top washcoat comprises rhodium supported on the alumina or ceria-alumina composite; and platinum supported on the ceria-alumina composite.

5. The catalytic article according to claim 1, wherein the first zone comprises palladium supported on each of the ceria-zirconia mixed oxide and alumina.

6. The catalytic article according to claim 1, wherein the first zone covers 10 to 90% of the entire substrate length from an inlet, wherein the second zone covers 10 to 90% of the entire substrate length from an outlet, wherein the top washcoat covers the 10 to 100% of the entire bottom washcoat length from the inlet.

7. The catalytic article according to claim 1, wherein the first zone covers 30 to 50% of the entire substrate length from an inlet and the second zone covers 50 to 70% of the entire substrate length from an outlet.

8. The catalytic article according to claim 1, wherein the amount of ceria-zirconia mixed oxide in the first zone is higher than the amount of ceria-zirconia mixed oxide in the second zone.

9. The catalytic article according to claim 1, wherein the weight ratio of the ceria-zirconia mixed oxide in the first zone to the ceria-zirconia mixed oxide in the second zone is 1.1:1.0 to 1.5:1.

10. The catalytic article according to claim 1, wherein the alumina present in the top and/or bottom washcoat is doped with a dopant selected from barium, lanthana, zirconia, neodymian, yttria or titania, wherein the amount of the dopant is 1.0 to 30 wt. % based on the total weight of alumina and dopant.

11. The catalytic article according to claim 1, wherein the alumina present in the top and/or bottom washcoat is selected from alumina, lanthana-alumina, titania-alumina, baria-alumina, baria-lanthana-alumina, baria-lanthana-neodymia-alumina, or any combination thereof.

12. The catalytic article according to claim 1, wherein the amount of ceria in the ceria-alumina composite present in the top and/or bottom washcoat is 5.0 to 30 wt. %, based on the total weight of the ceria-alumina composite.

13. The catalytic article according to claim 1, wherein the first zone comprises palladium supported on the ceria-zirconia mixed oxide or alumina or both in an amount of 50 to 100 wt. %, based on the total weight of palladium in the washcoats, preferably top washcoat and bottom washcoat, wherein the second zone comprises platinum supported on the ceria-alumina composite in an amount of 50 to 100 wt. %, based on the total weight of platinum in the wash coats, wherein the second zone further comprises 0 to 50 wt. % of palladium supported on the ceria-zirconia mixed oxide, based on the total weight of the palladium in the washcoats, wherein the first zone further comprises platinum supported on the ceria-alumina composite in an amount of Oto 50 wt. %, based on the total weight of platinum in the washcoats.

14. The catalytic article according to claim 1, wherein the first zone comprises palladium supported on the ceria-zirconia mixed oxide or alumina or both in an amount of 75 to 100 wt. %, based on the total weight of palladium in the washcoats, wherein the second zone comprises platinum supported on the ceria-alumina composite in an amount of 75 to 100 wt. %, based on the total weight of platinum in the washcoats.

15. The catalytic article according to claim 1, wherein the bottom washcoat comprises platinum supported on the ceria-alumina composite in an amount of 50 to 100 wt. %, based on the total weight of platinum in the bottom washcoat and the top washcoat comprises platinum supported on the ceria-alumina composite in an amount of Oto 50 wt. %, based on the total weight of platinum in the washcoats.

16. The catalytic article according to claim 1, wherein the amount of palladium is in the range of 0.02 to 2 wt. %, based on the total weight of the washcoats, the amount of platinum is in the range of 0.02 to 2 wt. %, based on the total weight of the washcoats, and the amount of rhodium is in the range of 0.01 to 0.5 wt. %, based on the total weight of the washcoats.

17. The catalytic article according to claim 1, wherein the weight proportion of palladium to platinum in the catalytic article is 9:1 to 1:13.

18. The catalytic article according to claim 1, wherein the weight proportion of palladium to platinum in the catalytic article is 3:1 to 1:1.

19. The catalytic article according to claim 1, wherein the ceria, calculated as CeO₂ of the ceria-alumina composite present in the top and/or bottom washcoat is 1.0 to 50 wt. %, based on the total weight of the ceria-alumina composite, preferably, the ceria, calculated as CeO₂ in the ceria-alumina composite present in the top and/or bottom washcoat is 5.0 to 50 wt. %, based on the total weight of the ceria-alumina composite, more preferably, the ceria, calculated as CeO₂ in the ceria-alumina composite present in the top and/or bottom washcoat is 5.0 to 30 wt. %, based on the total weight of the ceria-alumina composite, even more preferably, the ceria, calculated as CeO₂ in the ceria-alumina composite present in the top and/or bottom washcoat is 8.0 to 20 wt. %, based on the total weight of the ceria-alumina composite.

20. The catalytic article according to claim 1, wherein the ceria-zirconia mixed oxide present in the top and/or bottom washcoat comprises ceria, calculated as CeO₂ in an amount of about 20 to 50 wt. %, based on the total weight of the ceria-zirconia mixed oxide; and zirconia, calculated as ZrO₂ in an amount of about 40 to about 80 wt. %, based on the total weight the ceria-zirconia mixed oxide.

21. The catalytic article according to claim 1, wherein the ceria-zirconia mixed oxide present in the top and/or bottom washcoat comprises a dopant selected from lanthana, titania, hafnia, magnesia, calcia, strontia, baria, yttrium, hafnium, praseodymium, neodymium, or any combinations thereof.

22. The catalytic article according to claim 1, wherein the substrate is selected from a ceramic substrate, a metal substrate, a ceramic foam substrate, a polymer foam substrate, or a woven fibre substrate.

23. The catalytic article according to claim 1, wherein the amount ceria-zirconia mixed oxide present in the top and/or bottom washcoat is in the range of 10 to 90 wt. %, based on the total weight of the washcoats, wherein the amount of the alumina present in the top and/or bottom washcoat is in the range of 5.0 to 90 wt. %, based on the total weight of the washcoats, wherein the amount of the ceria-alumina composite present in the top and/or bottom washcoat is in the range of 10 to 80 wt. %, based on the total weight of the wash coats.

24. A process for the preparation of a catalytic article according to claim 1, wherein said process comprises:
a) preparing a bottom washcoat comprising a first zone and a second zone, wherein the first zone is obtained by preparing a first slurry comprising palladium supported on the ceria-zirconia mixed oxide or alumina or both and coating said first slurry on a first portion of the substrate; wherein the second zone is obtained by preparing a second slurry comprising platinum supported on the ceria-alumina composite; and coating said second slurry on a second portion of the substrate,
b) preparing a top washcoat by depositing a third slurry comprising rhodium supported on the alumina or ceria-alumina composite on the bottom coat, and
c) subjecting the substrate to calcination at a temperature ranging from 400 to 700° C., wherein the step of preparing the slurry comprises a technique selected from incipient wetness impregnation, incipient wetness co-impregnation, and post-addition.

25. An exhaust gas treatment system for internal combustion engines, said system comprising the catalytic article according to claim 1.

26. A method of treating a gaseous exhaust stream comprising hydrocarbons, carbon monoxide, and nitrogen oxide, the method comprising contacting said exhaust stream with the catalytic article according to claim 1.

27. A method of reducing hydrocarbons, carbon monoxide, and nitrogen oxide levels in a gaseous exhaust stream, the method comprising contacting a gaseous exhaust stream with the catalytic article according to claim 1.

28. Use of the catalytic article according to claim 1.
